(19) United States
(12) Patent Application Publication
(10) Pub. No.: US 2003/0220433 A1
(43) Pub. Date: Nov. 27, 2003

(54) Thermoplastic polymer comprising silicon compounds, its use, and process for its preparation

(76) Inventors: Holger Kliesch, Mainz (DE); Bodo Kuhmann, Runkel (DE); Ursula Murschall, Nierstein (DE); Rainer Kurz, Bad Schwalbach (DE); Ulrich Kern, Ingelheim (DE)

Correspondence Address: ProPat, L.L.C., 2912 Crosby Road, Charlotte, NC, 28211-2815, US

(21) Appl. No.: 10/242,054

(22) Filed: Sep. 12, 2002

(30) Foreign Application Priority Data
May 21, 2002 (DE) 102 22 357.2

(51) Int. Cl. B29B 9/02; B29C 47/00; B29C 55/02; B29C 55/14; B29C 55/16; C08K 3/34

(52) U.S. Cl. 524/442; 264/210.1; 264/140; 264/210.5; 264/210.6; 264/235.8; 264/342 RE; 524/492

(57) ABSTRACT

The invention relates to a raw material or masterbatch made from a thermoplastic and comprising silicon compounds, to a process for its production, and also to films produced using the polymer and having a thickness in the range from 0.5 to 1 000 μm. The polymer or masterbatch also comprises at least one stabilizer/free radical scavenger. The invention further relates to a process for producing the film.

The invention relates to a polymer or masterbatch made from a thermoplastic and comprising silicon compounds, to a process for its production, and also to films produced using the polymer and having a thickness in the range from 0.5 to 1 000 μm. The polymer or masterbatch also comprises at least one stabilizer/free radical scavenger. The invention further relates to a process for producing the film.

### BACKGROUND OF THE INVENTION

Silicon dioxide particles and related substances, such as aluminum silicates (e.g. kaolin) are additives frequently used industrially in polyester films, serving inter alia to produce an opaque appearance or produce surface roughness. They generally feature good binding into the polyester matrix.

However, a number of difficulties is often associated with the introduction of SiO₂ particles and of silicates into polyester polymers. Since they have a marked tendency toward agglomeration, their use at higher concentrations is limited or even impossible. Data associated with the preparation of polyester polymers loaded with these compounds generally refer to a content of about 2% by weight. The preparation of extrusion masterbatches, i.e. addition of the inert particles to the polyester polymer prior to or during the extrusion process, is difficult to impossible when using SiO₂ particles or silicates, since uniformity does not comply with the requirements placed upon film production. For this reason, the particles used in SiO₂-containing polyester polymers employed industrially are added in the form of concentrated SiO₂-containing dispersions (known as polymerization masterbatches) before the process of polycondensation of the polyesters has been completed, in order to achieve homogeneous distribution in the polyester polymer as it forms. However, here again a problem arises. Interactions and reactions between particles and polyester lead to development of an “apparent” viscosity, which causes a rapid rise in viscosity although the polycondensation reaction is as yet incomplete (i.e. at low molecular weight of the polyester). The viscosity of the polymerization batch in the stirred reactor becomes excessive, i.e. the higher the loading with the inert particles the greater the probability of premature undesired viscosity rise. Excessive means that the viscosity of the reaction melt is so high that the melt cannot then be discharged from the reactor. This tendency increases continuously from naturally occurring silicates through fumed SiO₂ and through to precipitated silica. Depending on the particle type used, there is therefore a maximum concentration which can be used in the polymerization masterbatch. Concentrations above 10 000 ppm are generally problematic.

When SiO₂-containing polyester polymers are used in film production, besides the problems in polymer preparation, there is an increased level of formation of undesired die streaks and large-surface-area die residues of increased-viscosity material (flow irregularities).

The Korean laid-open specification KR 2001-47779 describes a polyester film comprising inert particles and suitable as an electrical insulating material. In the preparation of the polyester polymer use is made of an agent to remove free radicals (free-radical scavenger) and also of a reducing agent, besides the inert particles. The action of these free-radical scavengers in reducing crosslinking in polyester materials is known. However, polyester polymers are mostly, i.e. more than 90%, composed of PET or PEN, and under conventional processing conditions have only very slight tendency toward side reactions which can be suppressed by these free-radical scavengers, and therefore polyester films are generally produced without addition of these compounds. However, in the case of applications such as the specification mentioned which need particularly low oligomer concentrations, their use may be cost-effective. The specification also states that it is undesirable for the inert particles to be used in a proportion of more than 1%, since disadvantageous effects otherwise occur, for example an increase in screen pressure during polymerization, i.e. a rise in viscosity, and disadvantageous effects during film production, and defects in the film as it passes through the machinery, caused, for example, by the increase in stiffness or by a change in the crystallization properties of the film.

It is an object of the present invention to eliminate the disadvantages described of the prior art.

### BRIEF DESCRIPTION OF THE INVENTION

The invention provides a thermoplastic which comprises silicon compounds and also comprises at least one stabilizer/free-radical scavenger, its use, and a process for its production. This thermoplastic polymer serves as an intermediate.

### DETAILED DESCRIPTION OF THE INVENTION

The thermoplastic polymer of the invention is in the form of a masterbatch which comprises from 100 to 10 000 ppm of the free-radical scavenger. The invention further relates to a process for producing the film at a thickness in the range from 0.5 to 1 000 μm, using the polymer comprising the silicon compounds. The silicon compounds are understood to be silicon dioxide particles, i.e. SiO₂, naturally occurring silicates, and aluminum silicates.

The thermoplastic masterbatches of the invention feature high loading of SiO₂ without any tendency to the occurrence of any apparent viscosity. Using these polymers films can be produced with no streaks and no flow irregularities.

For the purposes of the invention, silicon dioxide particles are naturally occurring silicates and aluminum silicates, such as kaolin, fumed silicon dioxide particles, such as ®Aerosil (Degussa, Germany), or precipitated silicates, e.g. ®Sylobloc (Grace Worms/Germany), ®Sylysia (Fuji, Japan), and ®Micloid (OCI, South Korea).

In the case of the transesterification process (DMT process), these particles are usually added in the form of a glycolic dispersion after the transesterification process or directly prior to the polycondensation process during preparation of the thermoplastic polymer. However, they may also be added even before the transesterification process has begun.

In the case of the direct ester process (TPA process), the addition is preferably at the start of the polycondensation process. However, later addition is also possible.

The concentration of SiO₂ in the matchbatches is in the range from 2 000 to 500 000 ppm, preferably from 21 000 to 100 000 ppm, and in particular from 30 000 to 80 000 ppm.

Examples of thermoplastics are polycondensates of terephthalic acid, isophthalic acid, or 2,6-naph-thalenedicarboxylic acid with glycols having from 2 to 10 carbon atoms, for example polyethylene terephthalate, polybutylene terephthalate, poly-1,4-cyclohexylenedimethylene terephthalate, polyethylene 2,6-naphthalenedicarboxylate, or polyethylene naph-thalate bibenzoate. They are also termed polyesters.

Preferred thermoplastics are polyethylene terephthalate (PET), polyethylene naphthalate (PEN), and mixtures of these.

Polyethylene terephthalate or polyethylene naphthalate are understood to be homopolymers, compounded materials, copolymers, or recycled materials made from these polymers, and other variants of the thermoplastics.

The polyesters may be prepared either by the transesterification process, e.g. with the aid of transesterification catalysts, e.g. salts of Zn, of Mg, of Ca, of Mn, of Li, or of Ge, or else by the direct ester process in which use is made of various polycondensation catalysts, e.g. Sb compounds, Ge compounds, or Ti compounds. Phosphorus compounds are used here as complexers for the transesterification catalyst after completion of the transesterification process.

When Ti-based polycondensation catalysts are used, the use of phosphorus compounds as complexers should be dispensed with entirely (maximum 5 ppm of P). When use is made of Sb catalysts or Ge catalysts or other polycondensation catalysts, the proportion of phosphorus components should be kept as low as possible. When the TPA route is used, concentrations below 10 ppm are therefore desirable, but when the DMT route is used the proportion can be up to 100 ppm. Higher proportions of phosphorus complexers lead, inter alia, to undesirable particulate by-products.

The polyesters may be composed of up to 50 mol %, in particular up to 30 mol %, of comonomer units, and it is possible here to vary the glycol component and/or the acid component. Examples of an acid component which may be present in the copolyester are 4,4-dibenzoic acid, adipic acid, glutaric acid, azelaic acid, succinic acid, sebacic acid, phthalic acid, isophthalic acid, the sodium salt of 5-sulfoisophthalic acid, and polyfunctional acids, such as trimellitic acid, and others.

It is important for the invention that the amount of stabilizer/free-radical scavengers added to the polyester polymers is from 100 to 10 000 ppm, preferably from 150 ppm to 9 000 ppm, in particular from 200 ppm to 8 000 ppm. The SV of the polyesters is generally in the range from 500 to 1 100.

The stabilizers added to the polyester polymer are selected as desired from the group consisting of the primary stabilizers, e.g. phenols or secondary aromatic amines, or from the group consisting of the secondary stabilizers, such as thioethers, phosphites and phosphonites, and zinc dibutyidithiocarbamate, and synergistic mixtures of these compounds.

Preference is given to the phenolic stabilizers. These include in particular sterically hindered phenols, thiobisphenols, alkylidinebisphenols, alkylphenols, hydroxybenzyl compounds, acylaminophenols, and hydroxyphenylpropionates, and mixtures of these (appropriate compounds are described by way of example in “Kunststoffadditive” [Plastics Additives], 2nd edition, Gächter Müller, Carl Hanser-Verlag and in “Plastics Additives Handbook”, 5th edition, Dr Hans Zweifel, Carl Hanser-Verlag).

In the case of the DMT process, these stabilizers are usually added after the transesterification process or directly prior to the polycondensation process, or else during the polycondensation process, in the form of glycolic solution or glycolic dispersion.

However, it is entirely surprising that the use of the stabilizers described permits higher loadings of silicon dioxide particles in the polyester.

An example of the preparation of the polyesters during preparation of the thermoplastic polymer (masterbatch) takes place by the transesterification process (DMT route). For this, the first stage transesterifies dimethyl terephthalate, using ethylene glycol. At temperatures of from 230 to 250° C. the use of an excess of ethylene glycol and addition of a transesterification catalyst produces diglycol terephthalate after ethylene glycol has been driven off, and the resultant methanol is also removed by distillation. After the transesterification process, a phosphorus compound is added as complexer for the transesterification catalyst. The second stage is the polycondensation (temperatures from 230 to 300° C.), using a polycondensation catalyst. The free-radical scavenger and the SiO₂ particles are dispersed separately in ethylene glycol, filtered where appropriate, and added in succession to the mixture. It is also possible here for the additives to be dispersed together and added. The addition may take place either prior to or during the transesterification process, or else at the start of or during the polycondensation process. After ethylene glycol has been driven off and the desired final viscosity has been achieved, the reaction melt is pelletized from the polycondensation reactor in a known manner. The masterbatch thus obtained is then used for further processing.

The thermoplastic polymer of the invention is used for producing silicon-dioxide-loaded films, the production process for which proceeds more reliably and more easily than in the prior art. For example, these films can be produced with no streaks and with no flow irregularities.

Besides SiO₂-containing particles, the polymer and the film may comprise other additives, e.g. in the form of other pigments (e.g. CaCO₃, TiO₂), or of color additives, of hydrolysis stabilizers, of flame retardants, of UV stabilizers, of optical brighteners, or of antistats.

The film of the invention is a single- or multilayer film, and the masterbatch may be used here during the production of one or more of these layers.

To produce the film, the thermoplastic polymer of the invention (if desired mixed with the other components) is dried in commercially available industrial dryers, such as vacuum (i.e. reduced pressure), fluidized-bed, or fixed-bed (tower) dryers. These dryers generally operate at atmospheric pressure using temperatures of from 100 to 170° C. In the case of the vacuum dryer, which provides the mildest drying conditions, the polymer traverses a temperature range from about 30 to 150° C. at a reduced pressure of 50 mbar. If desired, an after-dryer (hopper) may also be utilized.

The film of the invention is generally produced by the extrusion processes known per se.

The procedure for any of these processes is that the appropriate melts are extruded through a flat-film die, and, for solidification, the resultant film is drawn-off and quenched in the form of a substantially amorphous prefilm on one or more rolls (chill roll).

Die gap width is of decisive importance here for the thickness profile. The general rule is that the lower the gap width, the better the profile. However, when SiO₂-containing polymers are used the prior art generally requires the setting of higher gap widths than would be desirable for the profile, since otherwise there are more occurrencies of die streaks and die residues. Surprisingly, depending on the target thickness and on the processes following extrusion, it is possible when using the thermoplastic polymers of the invention to set gap widths which are from 2 to 25% lower than when using comparable film concentrations of SiO₂ derived from conventional polymers, without any occurrence of the problems mentioned. Another surprising feature here is that the content of the free-radical scavenger in the masterbatch is sufficient to stabilize all of the components of the film, so that no streaks or gel particles are formed.

In one preferred process of the invention, the amorphous film is then reheated and biaxially stretched (oriented), and the biaxially stretched film is heat-set.

The biaxial stretching is generally carried out sequentially, preferably first stretching longitudinally (i.e. in the machine direction=MD) and then transversely (i.e. perpendicularly to the machine direction=TD). This causes orientation of the molecular chains. The longitudinal stretching may be carried out with the aid of two rolls running at different speeds corresponding to the desired stretching ratio. For the transverse stretching, an appropriate tenter frame is generally utilized.

The temperature at which the stretching is carried out may vary within a relatively wide range, and depends on the desired properties of the film. Both the longitudinal and the transverse stretching are generally carried out at from TG+10° C. to TG+60° C. (TG=glass transition temperature of film). The longitudinal stretching ratio is generally in the range from 2.0:1 to 6.0:1, preferably from 3.0:1 to 4.5:1. The transverse stretching ratio is generally in the range from 2.0:1 to 5.0:1, preferably from 3.0:1 to 4.5:1, and that for any second longitudinal and transverse stretching carried out is from 1.1:1 to 5.0:1.

The first longitudinal stretching may, where appropriate, be carried out simultaneously with the transverse stretching (simultaneous stretching). It has proven particularly advantageous for both the longitudinal and the transverse stretching ratio to be greater than 3.5.

In the heat-setting which follows, the film is held for from 0.1 to 10 s at a temperature of from 160 to 260° C., preferably from 200 to 245° C. Following the heat-setting, or beginning during the heat-setting, the film is relaxed by from 0 to 15%, preferably from 1.5 to 8%, transversely and where appropriate also longitudinally, and cooled and wound up in the usual way.

Test Method

Standard viscosity (SV) and intrinsic viscosity (IV)

Standard viscosity SV (DCA) is determined on a 1% strength solution in dichloroacetic acid at 25° C.—the method being based on DIN 53726.

Intrinsic viscosity (IV) is calculated as follows from standard viscosity (SV):

IV(DCA)=6.907·10⁻⁴SV+0.063096

### EXAMPLES

Films of different thickness are used in the examples and comparative examples below, and had been produced by a known extrusion process.

Polymer Preparation

The polyesters were prepared by the transesterification process (DMT route). The first step transesterified DMT using ethylene glycol. At temperatures of from 230 to 250° C., the use of an excess of ethylene glycol and addition of manganese acetate (60 ppm of Mn) as transesterification catalyst produces diglycol terephthalate after ethylene glycol has been driven off, and the resultant methanol is likewise removed by distillation. After the transesterification process, H₃PO₃ (20 ppm of P) was added as complexer for the transesterification catalyst. The free-radical scavenger (if used) and the SiO₂ particles—the latter at a particle concentration of 15% by weight—were separately dispersed in ethylene glycol and added in succession to the mixture about 10 min after the transesterification catalyst. The dispersion comprising SiO₂ particles was filtered in advance through a 5 μm filter. The second stage was the polycondensation (temperatures of from 230 to 300° C.) using 200 ppm of Sb in Sb₂O₃ as catalyst. After ethylene glycol had been driven off and the desired final viscosity had been achieved, the reaction melt was discharged from the polycondensation reactor in the form of strands into a water bath, and then pelletized.

Film Production

Thermoplastic chips of the abovementioned masterbatch formulations and of the clear PET polymer were mixed in accordance with the ratios given in the examples and precrystallized for 1 minute at 155° C. in a fluidized-bed dryer, and then dried for 3 hours in a tower dryer at 150° C. and extruded at 290° C.. The molten polymer was drawn off from a die by way of a take-off roll. The film was is stretched at 116° C. in the machine direction by a factor of 3.8, and transverse stretching by a factor of 3.7 was carried out at 110° C. in a frame. The film was then heat-set at 210° C. and relaxed transversely by 4% at from 200 to 180° C. The production speed (final speed of film) was 280 m/min.

| | |
|---|---|
| Masterbatch MB1 | 3.0% by weight of Sylysia 320, 3.0% by weight |
| | of Aerosil TT600, and 94.0% by weight of |
| | PET, SV 800. |
| Masterbatch MB2 | 3.0% by weight of Sylysia 320, 3.0% by weight |
| | of Aerosil TT600, 0.1% by weight of ® Irganox |
| | 1010, and 93.9% by weight of PET, SV 800. |
| Masterbatch MB3 | 5.0% by weight of Sylobloc 44H and 95.0% by weight |
| | of PET, SV 800. |
| Masterbatch MB4 | 5.0% by weight of Sylobloc 44H, 0.2% by weight of |
| | ® Irganox 1330, and 94.8% by weight of PET, |
| | SV 800. |
| Polymer R1 | 100% of RT49 clear PET polymer from Kosa, SV 800. |

On two occasions during preparation of 5 batches of masterbatch MB1, the development of an apparent viscosity was so marked (there being a sudden 15% rise in viscosity after 60% of the expected polycondensation time) that the polycondensation process had to be terminated and the batches rejected. In the case of the other three batches of MB1, although the apparent viscosity effect was again present the masterbatch could be removed from the reactor with difficulty. In the case of MB3, it was impossible to produce a polymer suitable for film production. The viscosity curve for MB2 and MB4 in the polycondensation reactor corresponded with expectations.

Film Production

### Example 1

Mixture: 10% of MB2 and 90% of R1

Die gap width: 3 mm

Film thickness: 200 μm

Die residues and die streaks after 48 h of production: none

### Example 2

Mixture: 10% of MB2 and 90% of R1

Die gap width: 2 mm

Film thickness: 5 μm

Die residues and die streaks after 48 h of production: none

### Example 3

Mixture: 10% of MB4 and 90% of R1

Die gap width: 2.2 mm

Film thickness: 12 μm

Die residues and die streaks after 48 h of production: none

### Comparative Example 1

Mixture: 10% of MB1 and 90% of R1

Die gap width: 3 mm

Film thickness: 200 μm

Die residues and die streaks after 48 h of production: frequent streaks and die residues, die cleaning needed

### Comparative Example 2

Mixture: 10% of MB1 and 90% of R1

Die gap width: 2 mm

Film thickness: 5 μm

Die residues and die streaks after 48 h of production: frequent streaks and die residues, die cleaning needed

### Comparative Example 3

Mixture: 10% of mb1 and 90% of R1

die gap width: 2.3 mm

film thickness: 5 μm

Die residues and die streaks after 48 h of production: no streaks, occasional die residues, production possible but profile poorer due to higher gap width

1. A thermoplastic polymer comprising silicon compounds, and at least one stabilizer or free-radical scavenger.

2. The thermoplastic polymer as claimed in claim 1, which is in the form of a masterbatch comprising from about 100 to about 10 000 ppm, of the free-radical scavenger.

3. The thermoplastic polymer as claimed in claim 1, wherein the silicon compounds comprise silicon dioxide particles in the form of SiO₂, naturally occurring silicates, or aluminum silicates, in amounts of from about 2 000 to about 500 000 ppm.

4. The thermoplastic polymer as claimed in claim 1, which comprises, as stabilizers, one or more compounds selected from the group consisting of phenols, secondary aromatic amines, thioethers, phosphites, phosphonites, and zinc dibutyldithiocarbamate.

5. The thermoplastic polymer as claimed in claim 4, which comprises phenolic stabilizers, preferably sterically hindered phenols.

6. The thermoplastic polymer as claimed in claim 5, wherein the phenolic stabilizers are sterically hindered phenols.

7. A process for preparing a thermoplastic polymer comprising silicon compounds and at least one stabilizer or free radical scavenger, which comprises preparing the thermoplastic either by the transesterification process (DMT process) or else by the direct ester process (TPA process), where, in the case of the DMT process, the silicon compounds and the stabilizer or free-radical scavenger are added in the form of a glycolic dispersion prior to or during the transesterification process or at the start of or during the polycondensation process, and in the case of the TPA process are added at the beginning of the polycondensation process, and where the reaction melt is pelletized from the polycondensation reactor after the desired final viscosity has been achieved.

8. A process for producing a film with a thickness in the range from about 0.5 to about 1 000 μm from a thermoplastic polymer comprising silicon compounds and at least one stabilizer or free-radical scavenger, which comprises mixing thermoplastic chips of the thermoplastic polymer comprising silicon compounds and a clear PET polymer and extruding these, drawing off the molten polymer from a die by way of a take-off roll, and stretching, heat-setting, and relaxing the film.
